(19) United States
(12) Patent Application Publication
(10) Pub. No.: US 2007/0288313 A1
(43) Pub. Date: Dec. 13, 2007

(54) E-Coupon System and Method

(76) Inventors: Mark Brodson, Northbrook, IL (US); Vicki L. James, Schaumburg, IL (US); Jeffrey Jay Erdmann, Richfield, WI (US)

Correspondence Address: BOYLE FREDRICKSON S.C., 840 North Plankinton Avenue, MILWAUKEE, WI, 53203, US

(21) Appl. No.: 11/741,426

(22) Filed: Apr. 27, 2007

Related U.S. Application Data
(60) Provisional application No. 60/812,350, filed on Jun. 9, 2006.

(51) Int. Cl. G06Q 30/00

(52) U.S. Cl. 705/14; 705/16

(57) ABSTRACT

A method wherein a consumer registers for an electronic coupon (e-coupon) program and receives an e-coupon card programmed with consumer and corresponding e-coupon account identification information. The consumer selects available coupons from a website which are then loaded into the e-coupon account. Consumer package goods manufacturers (CPGs) are charged the downloaded value of the coupon plus a fee. The consumer may use the e-coupon card at any retailer that has electronic funds transfer (EFT) capabilities, such as credit/debit card acceptance. At a retailer's point of sale (POS) terminal, the consumer swipes the card and the cost of items having an e-coupon is adjusted by the corresponding e-coupon value and deducted from the consumer's final amount due. The CPG is also charged a redemption fee and the retailer is charged an interchange fee. Expired coupons are automatically removed from the account and their value refunded to the CPGs. Reports on redeemed coupons and redeemer profiles can be generated and provided to the CPGs or retailers.

### CROSS REFERENCE TO RELATED APPLICATIONS

This application claims the benefit of U.S. Provisional Application No. 60/812,350, entitled “E-coupon System”, filed Jun. 9, 2006, and U.S. application Ser. No. 11/285,053, filed Nov. 22, 2005 and claiming priority on U.S. Provisional Application No. 60/632,332 filed Dec. 1, 2004, the entireties of which are herein incorporated by reference.

### BACKGROUND OF THE INVENTION

1. Field of the Invention

The present invention relates in general to the field of a discount system and method. More particularly, the present invention relates to an electronic discount system and method including electronic coupons (“e-coupons”).

2. Discussion of the Related Art

Discount coupons have changed very little since they were first introduced. The only significant enhancement to the couponing process occurred in 1985 with the introduction of unique product codes, which enabled coupons to be scanned, rather than manually keyed into the cash register.

Issued and managed by the Uniform Code Council (UCC), a Universal Product Code (UPC) contains information identifying a manufacturer and an item in a numeric and graphical way. UPCs are most often found on items sold in retail outlets. Aside from UPC scanability, couponing is a very manual, labor-intensive process. While coupon redemption procedures vary by retailer, the typical process is diagrammed at FIG. 1.

The following facts provide further insight into current couponing practices:
342 billion coupons are distributed annually (based on 2004 totals).
Approximately 290 billion coupons were distributed via Sunday newspapers in 2004.
In 2002, 0.07% of coupons were downloaded from the Internet.
3.2 billion coupons or 1% of coupon distribution, were redeemed at an average cost of coupon value plus an eight-cent processing fee (paid by the manufacturer) in 2004.
Manufacturers incur significant incremental costs to send redeemed coupons to their own clearinghouses in an effort to detect fraudulent activity.

As indicated, the majority of coupons are distributed via newspapers. However, newspaper subscriptions and overall circulation are continuing to decline. In an article entitled “The Press is in Decline” dated May 8, 2005, the Washington Post made the dire prediction that newspaper subscriptions will die entirely by the year 2016. This ongoing decline in circulation leaves manufacturers in need of an alternative coupon distribution channel.

Due to the popularity of coupons among the general public, manufacturers continue to invest heavily in “couponing,” spending millions every year. Even a small shift in funds from current retailers and associated clearinghouses would generate significant revenues for a company implementing a more efficient process.

Further, at present, there is no consistent and comprehensive way for manufacturers to capture information on who is redeeming their coupons and using their products. Access to this information is of the utmost value to a manufacturer of consumer goods to assist with future product development and introduction, the creation of customer loyalty strategies and other business growth initiatives.

Moreover, e-commerce is rapidly expanding across the U.S. population with increases in Internet usage particularly strong among women. Further, the Promotion Marketing Association estimates that over 85% of females utilize coupons.

Electronic coupon cards do currently exist in the industry today. Research has found what appears to be a closed loop program wherein the coupon values are loaded onto grocery “loyalty” cards and redeemed only at the sponsoring grocer; hence, a closed loop program. This program was difficult to locate and does not appear to be widespread in the market.

Thus, electronic couponing and variations thereof have become more recently known in the art. For example, the below-referenced U.S. patents and published U.S. applications disclose embodiments that were at least, in part, satisfactory for the purposes for which they were intended. The disclosures of all the below-referenced prior United States patents and applications, in their entireties, are hereby expressly incorporated by reference into the present application for purposes including, but not limited to, indicating the background of the present invention and illustrating the state of the art.

U.S. Pat. Pub. No. 2004/0031856 and U.S. Pat. No. 6,607,136 each disclose a physical presence digital authentication system. U.S. Pat. No. 6,450,407 discloses a chip card rebate system. U.S. Pat. Pub. No. 2004/0056101 and U.S. Pat. No. 6,616,049 each disclose a retail sales customer marketing system with electronic coupon processing. U.S. Pat. Pub. Nos. 2002/0111864 and 2002/0077907 each disclose a system and method for managing a coupon. U.S. Pat. Pub. No. 2002/0194069 discloses business systems and methods for a consumer/vendor interface via the Internet to automatically provide discounts. U.S. Pat. Pub. No. 2003/0004831 discloses an interactive Internet shopping and data integration method and system. U.S. Pat. Pub. No. 2003/0130889 discloses a system and method for electronically generating, clipping and redeeming coupons. U.S. Pat. Pub. No. 2004/0054575 discloses a system, method and apparatus for distributing and redeeming customer-selected coupons. U.S. Pat. Pub. No. 2005/0109841 discloses a multi-interface compact personal token apparatus and methods of use. U.S. Pat. Pub. No. 2004/0249710 discloses methods and apparatus for implementing loyalty programs using portable electronic data storage devices.

However, for one reason or another, the above approaches do not solve the problem referred to herein. For example, some of the solutions in the above-cited art have the disadvantage of relatively high cost. Given that the financial and consumer products industries are competitive businesses, a preferred solution will be seen by the user as being cost effective and worthwhile. A solution is cost effective when it is seen by the user, e.g., a manufacturer, as compelling when compared with other potential uses that the user could make of limited resources.

What is needed therefore is an e-coupon system that preferably: 1) allows for the redemption of coupons with the purchase of qualifying products; 2) “loads” coupon information into an electronic “account” accessible by a card or device; 3) is “reloadable” by the consumer via the Internet, or other access portal so as to replace the need for coupon clipping; 4) offers direct benefits including built-in anti-fraud components and coupon clearing cost efficiencies for consumer product manufacturers and service providers; 5) provides direct benefits to consumers through the elimination of manually clipping and sorting coupons; 6) provides direct benefits to retailers that redeem coupons by expediting the coupon value reimbursement process; 7) increases stored value systems revenue potential and production revenues; and 8) allows some costs to be absorbed by customers who sign up for an e-coupon card or to be shared across multiple manufacturers and coupon sponsors. The term “coupon,” as used herein, may be represented in various forms such as a certain amount of dollars or cents off, a percentage off, two-for-one offers, a bonus buy, a gift with purchase, a discount and so on.

### SUMMARY AND OBJECTS OF THE INVENTION

By way of summary, the present invention leverages existing stored value card technology to preferably create an electronic coupon system that enables electronic coupon redemption at any retail outlet having electronic funds transfer (EFT) capabilities. Hence, this is considered an “open loop” system. An open-loop system is further described by the Assembly Committee on Banking and Finance in the following excerpt from an information hearing on The Growing Use of Stored-Value Cards dated Oct. 12, 2005. “With an open-loop system, the cardholder can use the card for multiple purposes and at many points of sale in order to purchase goods or services . . . ” “Open-loop cards may be issued for use in one mall where the cardholder can use the card to make purchases at any store in the mall.” “Other open-loop cards may be usable at any place a bank card is accepted, not just the stores in one mall.” In one embodiment, a coupon account would be created and “reloadable” with coupon values by the consumer, preferably via the Internet, and would replace the need for coupon clipping. This coupon account would be accessible by a card or other coupon account access device at a point of sale (POS) terminal. The clearing of coupon values after consumer redemption may also be an automated process.

In another embodiment, the invention is a discount system that comprises a global communications network, at least one server operably connected to the network, an access portal on a server including purchaser or consumer instructions of use and information regarding discounts available from a multitude of coupon sponsors, an account access device for accessing purchaser account information from a database, and an apparatus which accepts at least one of product and service identification data. The term “coupon sponsor,” as used herein, is a product, goods or service provider offering coupons.

The apparatus also preferably reads product or service information or identification data such as a UPC or SKU from a bar code on the product. The SKU (Stock Keeping Unit) is a separate identification number used on consumer goods. The apparatus, e.g., a scanner or reader, preferably further reads account information from the account access device, e.g., a plastic card having readable information, a cell phone, a device having a magnetic strip, a smart chip, a key fob, a wireless device such as that found in co-pending U.S. patent application Ser. No. 11/494,958 filed on Jul. 28, 2006 and entitled “Authorization System and Method”, the contents of which are hereby incorporated by reference, or some other a portable electronic account information storage media. A processing system is provided to treat the discount as an electronic tender type at a point of purchase or point of sale.

In yet another embodiment, the invention is an electronic coupon system that comprises an account access device and an access portal containing multiple electronic coupons from various coupon sponsors. The access portal has multiple sorting options including sorting by product, service, coupon sponsor, and expiration date. The access portal, e.g., an Internet website, also preferably contains a product or service description and coupon value. An interface, on the website, allows a purchaser or consumer to select a coupon or coupons of interest. The portal allows a first-time visitor or consumer to enroll in the electronic coupon system program by entering required information and creating an account. For a first time visitor, a back end processor preferably electronically loads, or programs, the account with information, e.g., an account access code or number, and/or sends the account access device, e.g., a card, to a product or service purchaser or consumer.

In still another embodiment, the invention is a system for allowing repeat website visitors or customers to select e-coupons. The system comprises a card access device having a code, e.g., alphanumeric personal ID, associated therewith for e-coupon redemption. A processor, e.g., a third party clearing house computer, “loads” the account or card with data, such as selected product coupon discount values, UPCs, and expiration dates. Cash reserves from at least one selected coupon sponsor, such as a manufacturer are used to cover the discount value of the selected coupons. A mechanism, e.g., the Internet, allows the purchaser or customer to access e-coupon card and/or account information from an access portal, e.g., an e-coupon website, via a mobile device, e.g., cellular phone or a PDA. Once the user or would-be purchaser has access to the website, the purchaser/consumer uses a means to sort coupons of interest by at least the brand, product category, and layout of a preferred grocery store. Another portal, such as a web link or icon, allows a purchaser to sign up for alerts, e.g., via email, that include a notice prior, e.g., 2 days, to an expiration date of a selected unredeemed coupon. Another alert may be triggered when a coupon for a selected desired product becomes available, e.g., 8 oz. container of Scrubbing Bubbles® cleaner.

In yet another embodiment, the invention is a system that comprises a manufacturer's coupon card redeemed at a point of sale that is preferably processed like a stored value card. Here, the system includes an account associated with the card. Coupon values for qualifying, purchased items are removed from the account during the redemption process, e.g., batch or real-time processing. Unredeemed coupon values that expire are automatically eliminated from the account and those corresponding cash reserves are released back to the manufacturer. The system preferably has open-loop access so that the card is redeemable at any retailer that currently accepts a multitude of coupon sponsors' coupons and has stored value card acceptance capabilities at a point of sale.

In one embodiment, a mechanism, such as Bluetooth® or WI-FI, e.g., on-line or via cell phone technology, also allows a purchaser to check account balances and content. The purchaser may “reload” the account with coupon values at any time via the mechanism, e.g., on-line or via cell phone.

In still another embodiment, the invention is an electronic coupon redemption and processing system in communication with a financial communications network. The system includes a network portal, and at least one server operable with the network portal. At least one server is operable with a financial communications network and is used to process financial transactions. A database of the system is connected to the network and contains consumer account information. A database also preferably contains consumer coupon selection information. A database preferably contains available manufacturer coupon information. Of course, one of ordinary skill in the art will realize that this could be multiple databases or just one database.

The system also preferably includes a portal accessible via the Internet and includes consumer instructions for use and information regarding coupons available from a multiplicity of coupon sponsors. Once a consumer's account is set up, the consumer may access the account via an account access device. The account is also preferably accessible by a payment processing system, e.g., a point of sale (POS) terminal at a merchant having a card reader that is connected to the network.

In yet another embodiment, the invention is a coupon system that comprises a computer and a website containing electronic coupons from sponsors having multiple sorting options including by item type, sponsor and expiration date. The website's pages preferably contain a description of the discounted item along with a discount value. A tool, e.g., a mouse and/or icon, allows consumers to select coupons in which they are interested on the website. A linked portal allows a first-time visitor to set up an account by entering contact information and other requested information.

An e-coupon processing business entity preferably creates a consumer account and houses selected coupon offers and consumer information. This business entity also preferably creates and sends an account access device to the consumer. This business entity preferably further updates the consumer account as additional coupon offers are selected by the consumer from the website, as coupons are redeemed by the consumer, or as previously selected unredeemed coupon offers expire.

A method of an electronic discount system in one embodiment preferably comprises the steps of: 1) setting up an e-coupon service for participating coupon sponsors such as consumer product manufacturers; 2) producing an account for a consumer; 3) processing a consumer coupon redemption transaction; 4) charging a coupon selection and/or redemption service charge; 5) creating consumer profile reports; 6) making the reports available to the at least one of the manufacturer and retailer; 7) charging the report creation to at least one of the manufacturer and retailer; and 8) facilitating promotional communications between the manufacturer, retailer, and a targeted consumer.

In another embodiment, the method of an electronic discount system further comprises the steps of producing an electronic discount account card for a coupon redeemer; charging the cost of producing the card to at least one of a retailer, a redeemer, and a coupon sponsor; charging a service charge to a coupon sponsor for setting up an e-coupon service; charging a coupon redemption service charge to coupon sponsors; charging a fee for the transaction to a retailer; creating a redeemer report and making the report available to the coupon sponsor and/or retailer; and compiling redeemer profile reports for coupon sponsors and/or retailers.

These, and other aspects and objects of the present invention, will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a prior art flow chart diagram;

FIG. 2 illustrates a flow chart diagram according to one embodiment of the present invention;

FIG. 3 illustrates a system diagram according to one aspect of the present invention;

FIG. 4 illustrates an exemplary access portal according to one aspect of the present invention;

FIG. 5 illustrates a system diagram according to a further aspect of the present invention;

FIG. 6 illustrates a process flow diagram according to one aspect of the present invention;

FIG. 7 illustrates a process flow diagram according to another aspect of the present invention;

FIG. 8 illustrates a process flow diagram according to another aspect of the present invention;

FIG. 9 illustrates a business process flow diagram according to another aspect of the present invention; and

FIG. 10 shows one other alternative embodiment of the present invention.

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose. For example, the words connected, connection, or terms similar thereto are often used. They are not limited to direct connection or attachment but include connection or attachment through other elements where such is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

1. System Overview

The invention is a system for allowing a consumer to redeem an e-coupon. The system preferably comprises a mobile access device for a coupon redeemer that has an account associated with it for coupon redemption. The system also includes a processor for updating the account with selected product coupon values, product information, and expiration dates. Coupon sponsors, such as consumer product manufacturers are asked, e.g., through cash reserves, to cover the value of each selected product coupon.

A mechanism allows registered redeemers to check and print out their e-coupon account contents from a website if the access device is a card, or to access account contents directly via the device if it is a cellular phone, PDA, or other wireless device. The mechanism preferably allows consumers to check account balances and other content via a portal such as an Internet website with information pages, wireless device, or a cell phone. The mechanism also preferably allows consumers to update their account with additional coupon values at any time via the portal.

The e-coupon access device of the present invention is preferably an “open loop” system card. This means that the card can be redeemable at any retailer that currently has electronic debit, credit or gift (stored value) card acceptance capabilities.

System requirements preferably are straight forward, as much of the technology required to support the e-coupon card product offering currently exists. These requirements include a web portal for consumer access to coupons. The web portal could be developed and maintained internally by an e-coupon processing company or by partnering with an existing on-line coupon website. One such website is www.smartsource.com, a News America Marketing company. This website features a vast array of coupons available for printing by consumers. It supplements the Smart Source Magazine, the nation's largest coupon freestanding insert (FSI), with distribution to 70 million households via 1,200 newspapers. Relationships with consumer package goods manufacturers (CPGs) such as Procter & Gamble are already in place at News America Marketing.

A second requirement is account set up ability, including preferably card order processing capability which can be either outsourced or developed internally by the e-coupon processing business. Producing cards, programming cardholder identification information, and fulfilling card orders could also be outsourced or handled internally. Additional requirements, such as stored value card processing capabilities may be handled by electronic payment processing companies such as Metavante Corporation. Finally, data management and report creation could be handled by a company providing strategic customer information services such as Metavante. Examples of reports include demographic and geographic profiles of e-coupon account holders, by product and product category and comparison of download and redemption trends against download and redemption trends of other manufacturers within the same product category. Additional system features will become apparent from the detailed description below.

2. Detailed Description of Preferred Embodiments

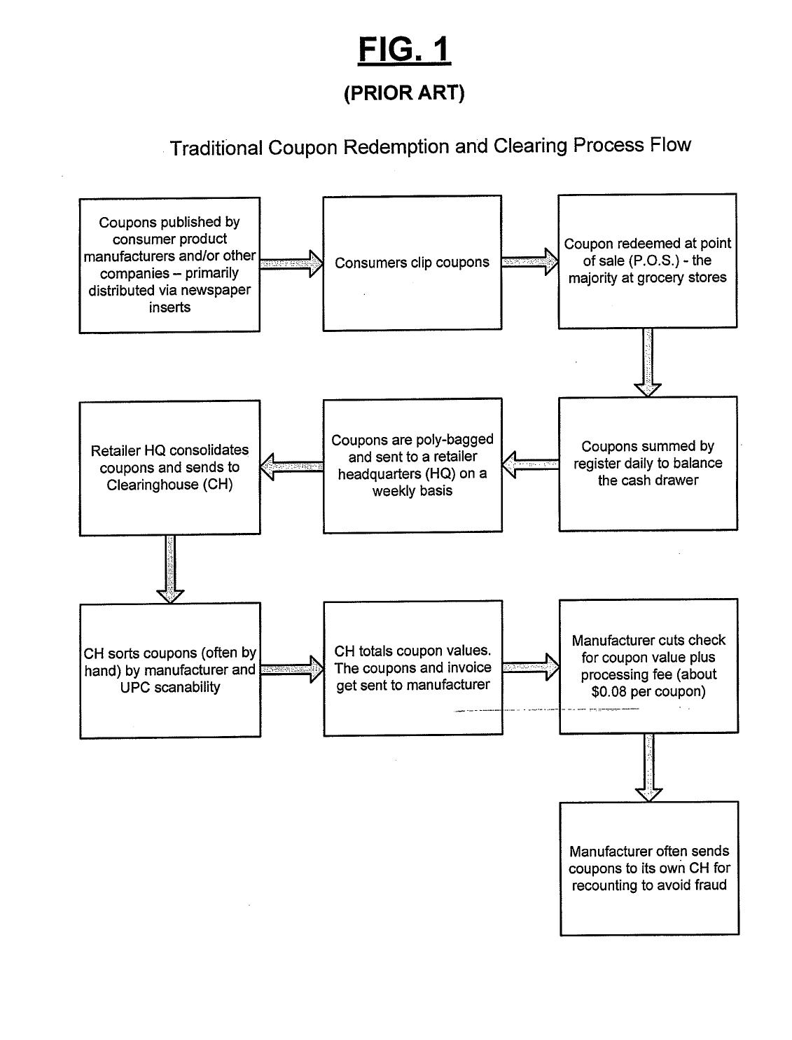

FIG. 1 shows a prior art process of traditional coupon redemption and clearing. First, paper coupons are published by consumer product manufacturers and/or other companies. The coupons are primarily distributed through newspaper inserts or direct mailings. Consumers clip and save these coupons for use while shopping. As noted, the primary source of coupons is newspapers. Next, the paper coupon is redeemed at the point of sale terminal at a retailer. Presently, the majority of coupons are redeemed at grocery stores. At the end of each business day, coupons are summed by register at the retailer to balance cash drawers. Coupons are then typically bagged in clear plastic bag, e.g., polybags. In larger chains, polybags are regularly collected and sent to the retailer headquarters, e.g., on a weekly basis. The retailer headquarters consolidates the coupons and sends them to a clearinghouse. The clearinghouse sorts the coupons, often by hand, by manufacturer and UPC scanability. The clearinghouse totals the coupon values and sends the coupons and an invoice to the manufacturer. The manufacturer then issues a check to the clearinghouse or directly back to the retailer that originally redeemed the coupons. The invoice includes the coupon values plus a processing fee, which might be as much as eight cents per coupon. The manufacturer may then send the coupons to its own clearinghouse for recounting to detect fraud or inaccurate coupon counting.

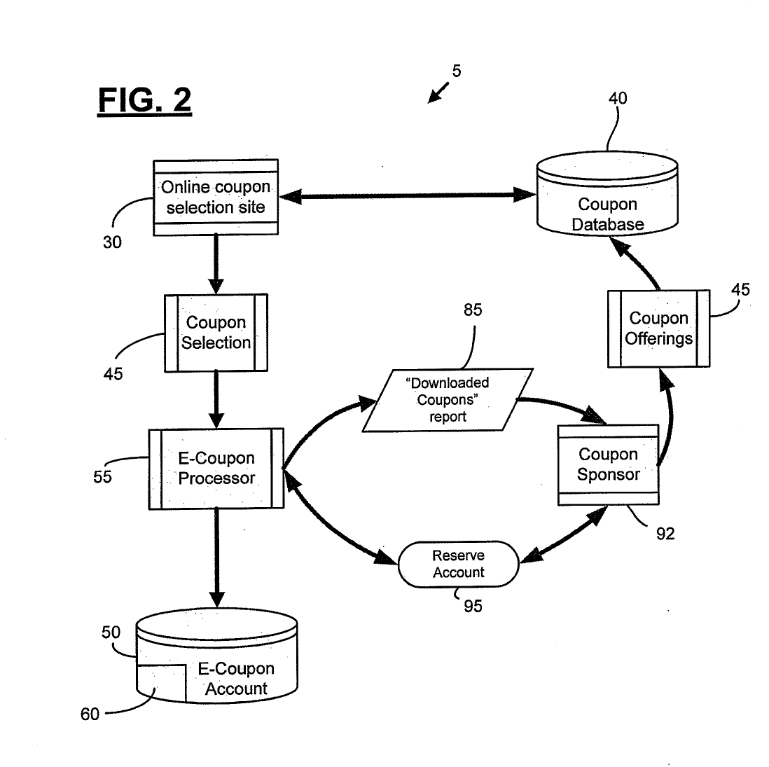

Various preferred aspects of an e-coupon system of the present invention are best illustrated in FIGS. 2-9. As shown in FIGS. 2 and/or 4, the system 5 includes a consumer 10 that accesses the e-coupon system 5 through a global communication network 20, preferably the World Wide Web via the Internet. The consumer 10 may be defined as anyone who may use the system including retail shoppers, commercial/industrial buyers, and other purchasers or would be customers.

Once access is gained to the system 5, the consumer 10 is able to visit a coupon selection website 30. The coupon selection website 30 is connected to a coupon database 40 containing UPC and other information for goods and services for which e-coupons 45 are offered. The consumer 10 is able to search, view and select coupons 45 of interest for goods and/or services that the consumer 10 may be purchasing or utilizing in the future.

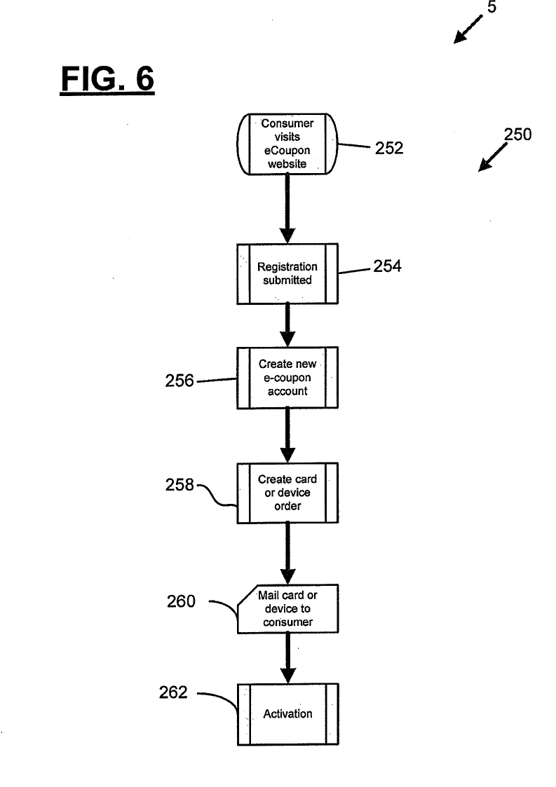

Once the consumer 10 has established an e-coupon account 50 through a registration process, e.g., FIG. 6, and a coupon selection is made (shown as block 45), preferably an e-coupon value processing system or processor 55 credits or “loads” the consumer's e-coupon account 50 with detailed coupon 45 information, such as, coupon UPC, amount, and expiration and stores this information in a database 60 associated with the consumer's e-coupon account 50. The term “loads” as used in this application means the updating of the consumer's account 50 with a coupon 45 amount and/or other coupon/product information. The e-coupon processor 55 may also be responsible for providing a report 85 of selected coupons 45 and their associated values to the coupon sponsors, such as a consumer-products manufacturer 92.

Once an e-coupon 45 is selected, the coupon sponsor 92 preferably transfers funds to a cash reserve account 95 that may be accessed by the e-coupon processor 55 to reimburse merchants, such as retailers, via electronic funds transfer (“EFT”), for the amount of the e-coupon 45 upon redemption.

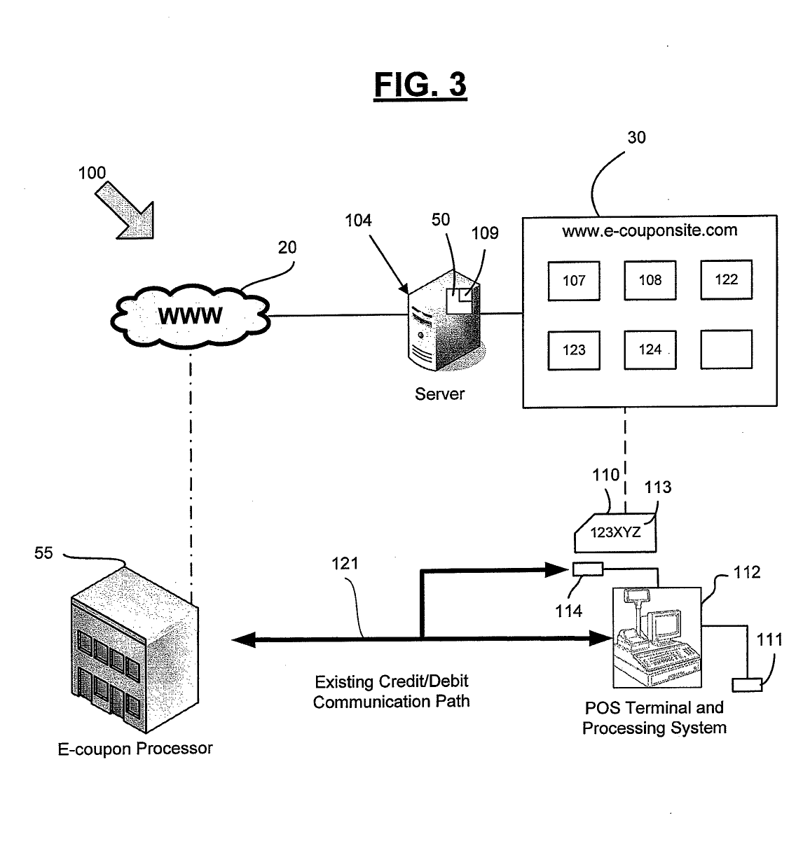

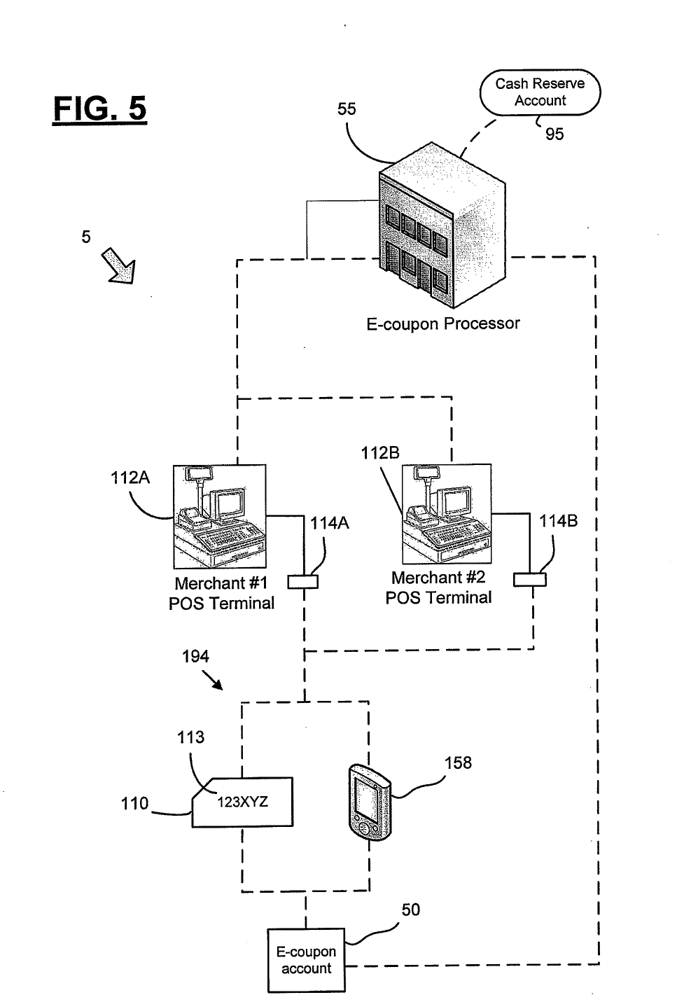

FIG. 3 shows another aspect of the invention, for example, a system 100 which includes the global communications network 20. Connected to the network 20 is preferably a server 104 operably connected to an access portal, e.g., e-coupon website 30. At the access portal 30 consumers, i.e., purchasers, are provided with instructions 107 for account registration/setup and usage as well as information 108 regarding available coupons from a multitude of coupon sponsors 92. After the initial registration process is complete, an account 50 containing consumer purchaser information 109 is created and housed on the server 104. This information can be accessed through an account access device 110, (and 158 in FIG. 5) which may be a card, key fob, cell phone, personal digital assistant, personal computer, or similar device. Databases containing consumer account information 122, consumer coupon selection information 123 and available manufacturer coupon selection information 124 are connected to the network 20 via the server 104.

The global communications network 20 is also connected to a “back end” processor, e.g., e-coupon service processor 55. The processor 55 is preferably connected to an apparatus, e.g., POS terminal and processing system 112 through the existing electronic credit/debit processing connection 121 (e.g., so called “credit rails”). Such a system is described in U.S. application Ser. No. 11/285,053, the entirety of which is incorporated herein by reference. Moreover, the connection 121 between the POS terminal 112 and the e-coupon processor 55 here may be directly through the e-coupon processor's EFT network utilizing the ISO 8583 standard, through another financial institution's EFT network, through a virtual private network (VPN) via the Internet, a direct line, or some other similar communication means. The information exchange between the terminal 112 and the e-coupon processor 55 includes the consumer's e-coupon account information and the UPCs from the pending transaction. The exchange also includes an authorization amount response corresponding to the total coupon discount.

At the point of purchase, point of sale or point of redemption, information, e.g., SKUs or UPCs are read into the processing system 112 for each product to be purchased through a device such as a UPC reader 111 connected to the system 112. Purchaser account identification information 113 stored on the e-coupon account card, i.e., access device 110, is also read into the system by an apparatus such as debit/credit card reader 114. This is done in conjunction with, or at the conclusion of, the scanning done to total the order.

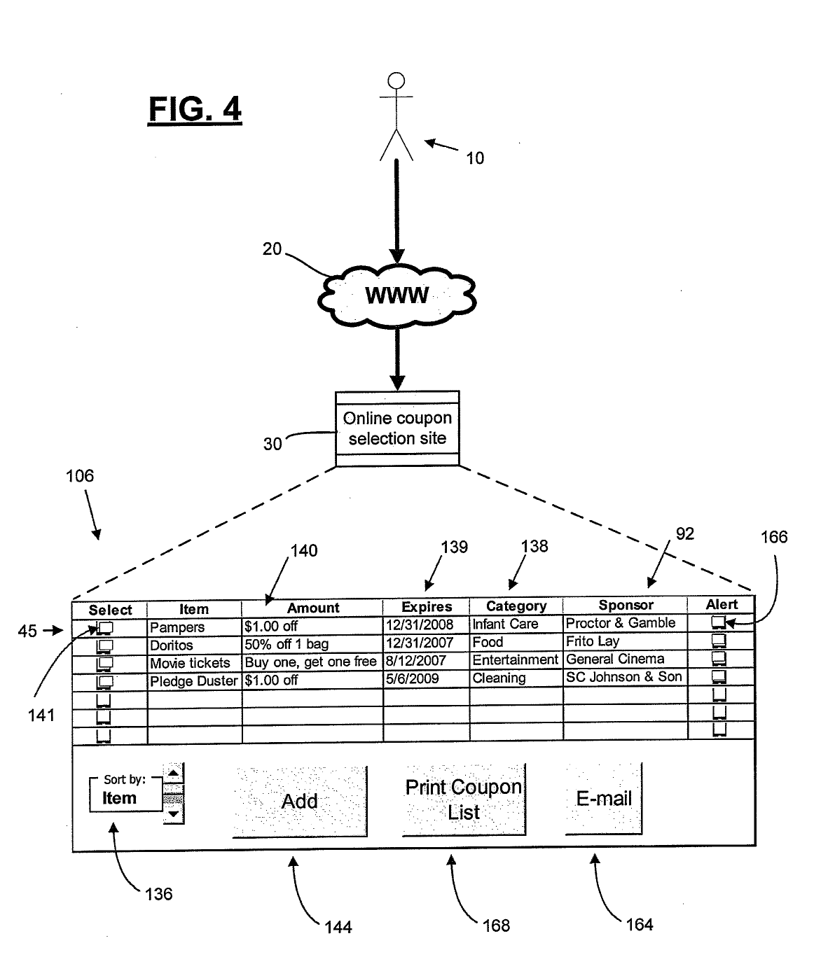

Referring again to FIG. 4, a system for selecting e-coupons from an electronic coupon website 30 is shown. The purchaser i.e. consumer 10, accesses website 30 through a mechanism, e.g. the Internet 20, via computer, PDA, or other connectivity method. A listing of electronic coupons (e-coupons) 45 is displayed on the screen in its entirety or limited by searching by coupon sponsors 92, by coupon category 138 or by other searchable fields. Such coupon sponsors 92 may be manufacturers or service providers such as S. C. Johnson & Son, Inc., General Cinema, and the like. The listing preferably has multiple sorting capabilities 136 that permit a consumer 10 to sort by manufacturer or service provider 92, product or service type, product size, brand-name, particular store layouts, expiration dates 139, and so on. Description and value information 140 is also available for each e-coupon 45 and underlying item product listed on the website 30. An example of available information for an e-coupon 45 may include, Pledge® Dusters, $1.00 off any size, expires Dec. 31, 2010, General Cinema Movie Admission, $0.75 off, and so on. An interface 141 e.g., a clickable icon or selectable check box, allows purchasers 10 to select coupons 45 of interest. A tool, e.g., a mouse, may be used to make such a selection. A link or portal, e.g. an icon leading to an online registration form, may also be present to allow a first-time user to enter required information, set up an account 50 to select e-coupons 45, and make future selections using the website 30. Such a link may also allow users to update their account information, e.g., address, married name. Once the coupons 45 have been selected, a coupon list may be printed via a mechanism, e.g., button 168. Other information about the product or the coupon 45 may also be printed in this manner.

In addition, the consumer 10 may select an e-mail button 164 on the website 30 to get further information about the products and coupons 45 such as alerts prior to coupon 45 expiration dates. In one embodiment, a check box 166 may be checked to receive product or coupon alerts for selected products when they become available.

In a separate embodiment, the account access device 110 may only accept e-coupons 45 from a particular manufacturer 92. Referring again to FIG. 2, a processing company 92 updates the account 50 electronically with the e-coupons 45 that have been selected by the consumer 10. The consumer's account 50 may also be updated as subsequent coupon offers are selected from the website 30 or as previously selected but unredeemed coupons 45 expire.

FIG. 5 illustrates another aspect of the electronic coupon system 5. Here the system 5 is shown with the e-coupon processor 55 connected to a plurality of merchant systems or terminals 112. The processor 55 processes the e-coupons 45 but also accesses cash reserves 95 from various manufacturers 92 that may be used to cover the value of coupons 45 redeemed by the consumers 10 at the terminals 112. One mobile account access device 158 shown in this aspect a cell phone, which via a mechanism, such as a wireless Internet card or Bluetooth® technology, enables purchasers to check account balances, display and/or print e-coupon account contents and to electronically reload their accounts 50 with additional e-coupons 45 at any time. The device 158 may also be a personal digital assistant or personal computer that has access to a global communications network 20, e.g., the World Wide Web. Alternatively, a plastic card 110 having readable information 113 such as an associated account identifier or unique alphanumeric digits, may serve as the account access device 110 at a POS terminal 112. At the point of sale the card 110 provides open loop 194 access to the electronic coupon system 5. Open loop access means that each coupon 45 stored in the account 50 can be redeemed or used at a variety of different merchants or for a variety of different products. For example, when a consumer 10 selects a product and presents the card 110 at one merchant's POS terminal 112A, e.g., General Cinema Theatres, the card 110 is read by any of the merchant's existing POS or credit/debit card readers 114A. In an open loop system, the consumer 10 may also present the card 110 at a POS terminal 112B of a second merchant, e.g., Pick 'n Save, using the second merchant's existing readers 114B. The card 110 can be used at multiple merchants, for example, at Wal-Mart, ExxonMobil gas stations, a dry cleaner, a restaurant, or the local mom-and-pop corner grocery store as long as they have stored value card acceptance capabilities at their POS terminals.

FIG. 6 shows a flow diagram of another aspect of the electronic coupon system 5. In this figure, the consumer registration module 250 is shown. In the first step 252, the consumer visits the e-coupon website. In the next step 254, the consumer has completed a registration process to establish an individualized account. The coupon system processor may create the e-coupon accounts and related consumer access systems inhouse and shown as step 256.

In step 258, an order is created for the consumer, so that the consumer may receive his e-coupon card. In one embodiment, the card may be sent to the consumer pre-funded with introductory offers and coupons like a gift card. Alternatively, the card may come with an account loaded with e-coupons selected by the consumer if the coupon system processor permits the user to select e-coupons before the card is activated, similar to a debit card account. In step 260, the e-coupon card is mailed to the consumer. If deemed a requirement, the card is then activated by the consumer in step 262 via the website prior to use or at a merchant's POS terminal when used for the first time. The point of purchase or coupon redemption may alternatively be an online grocery store website such as www.peapod.com.

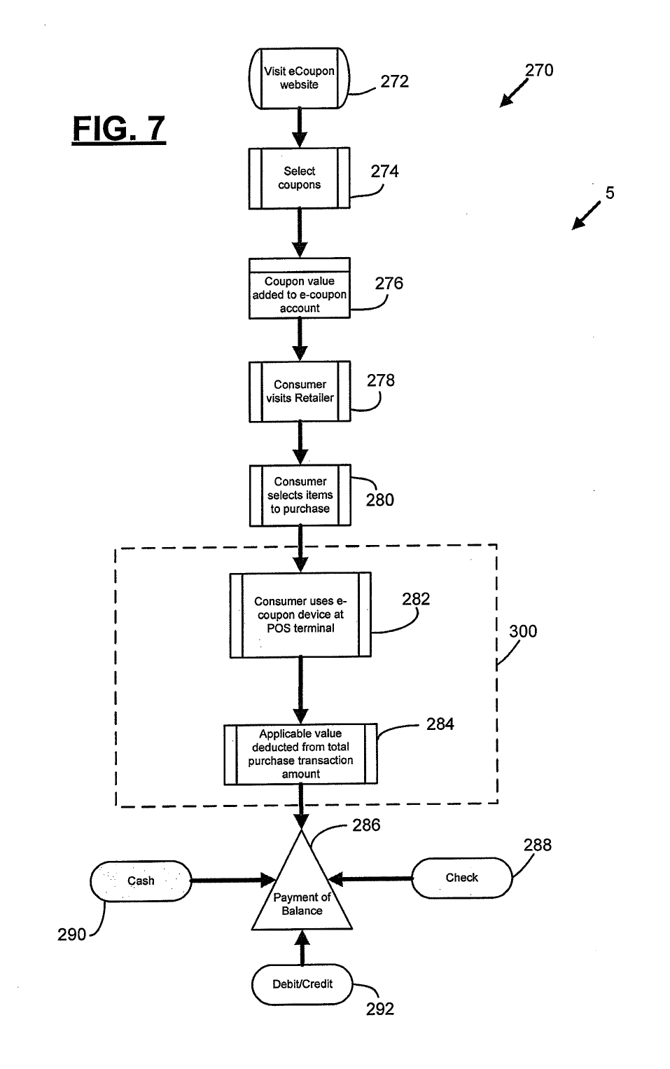

FIG. 7 shows another aspect 270 of the electronic coupon system 5. After establishing an e-coupon account via consumer registration module 250 (FIG. 6), the consumer visits the e-coupon website in step 272, and in step 274 selects from a multitude of manufacturer coupons to add to his e-coupon account. The e-coupons and associated coupon information are then added to the consumer's account in step 276. Additional e-coupons can be added to the account at any time. In step 278, the consumer visits a retail establishment such as a bricks and mortar store or a website. The consumer selects items to purchase as shown in step 280. As part of the checkout process, in step 282 the consumer presents his e-coupon account access device at the terminal to access the e-coupons stored in his e-coupon account by, for example, swiping a magnetic strip on the back of an e-coupon card (i.e., the account access device in this example).

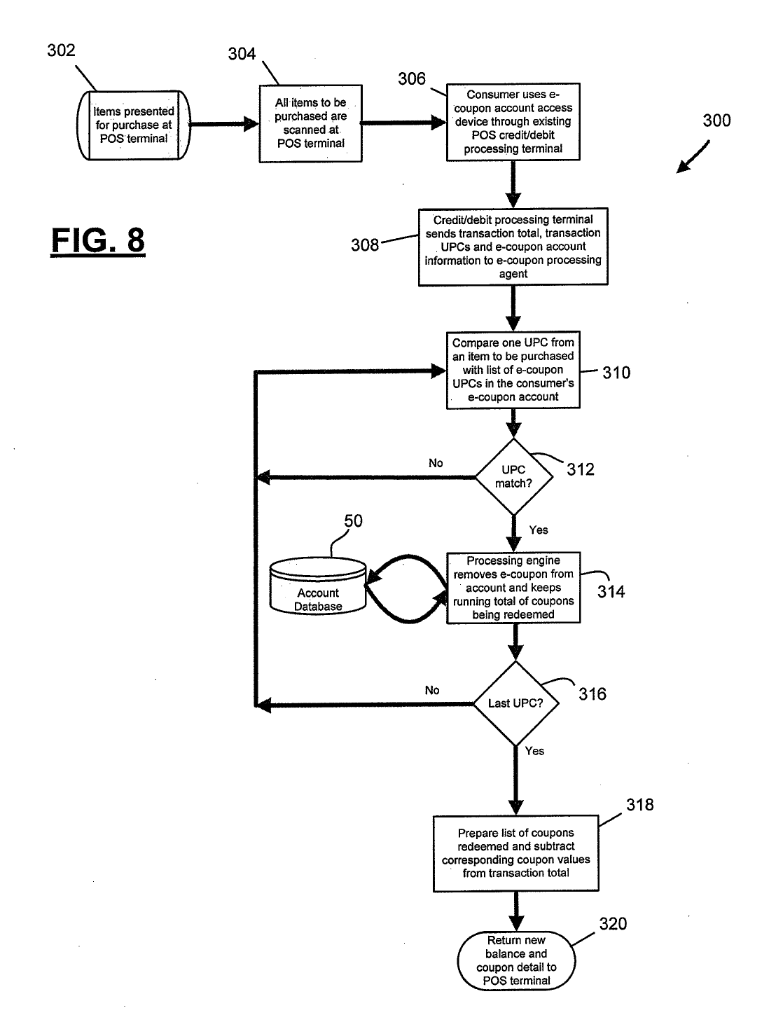

In step 284, the applicable coupon values are electronically deducted from the consumer's total purchase amount. The coupon value is essentially treated as one form of electronic tender type, in the same way that debit, credit or gift cards are also treated as electronic tender types. Steps 282 and 284 are part of the coupon authorization process 300 that processes the applicable e-coupons and is shown in greater detail in FIG. 8. After the coupon value is applied, a remaining balance, if any, is presented to the consumer in step 286. This balance represents the total retail price of the selected product or products after the coupon values have been subtracted from the total. The payment of the remaining balance can be accomplished by check 288, cash 290, debit or credit card 292, gift card, or any other accepted tender types.

As mentioned, FIG. 8 shows the basic flow of the electronic coupon authorization/substantiation process, or financial system, 300 for the e-coupon system 5. The process starts after the items are presented for purchase in step 302 and then scanned at a checkout or POS terminal in step 304. In step 306, the consumer presents the e-coupon account access device, e.g. e-coupon card, to be scanned or swiped by a standard credit/debit reader connected to the POS terminal. Alternatively, the consumer could use a personal information number (PIN) to access the e-coupon account.

In the preferred embodiment shown, at step 308 the POS terminal and processing system sends the entire list of UPCs from the pending transaction to the e-coupon processor 55. Thereafter, in step 310, a processing engine at the e-coupon processor 55 separates and examines each UPC individually. In an alternative embodiment not shown, the POS terminal 112 could determine the “eligible products” and send only the UPCs for the eligible products to the e-coupon processor 55. In this context, eligible products are products associated with coupon sponsors 92 who have contracted with an e-coupon service processor 55 to create and distribute e-coupons 45 for at least some of their products. In this alternative embodiment, each UPC may be compared to a first data structure containing eligible item identifiers to determine if the UPC represents an eligible product by the POS terminal 112, by the e-coupon processor 55 or by both.

In step 312 of the preferred embodiment, the processing engine determines whether a UPC represents an item for which a coupon exists in the consumer's e-coupon account. If it does not, the process moves back to step 310 and a new UPC is selected and examined. If, in step 312, the processing engine determines that the e-coupon is in the consumer's account, i.e., the UPC is for an authorized product, it then, in step 314, tallies the coupon values (which are applied in a later step after all the UPCs have been examined and accounted for) and removes the coupon from the consumer's account 50. The process then moves to step 316 to determine whether there are more UPCs from the pending transaction to be examined. If so, the process moves back to step 310 and another UPC is selected and examined. In an alternative embodiment not shown, the substantiation process steps could be accomplished by comparing each UPC to a second data structure containing authorized item identifiers, i.e., e-coupons 45. In this way, the UPC could be thought to represent an “authorized product.”

In the preferred embodiment, after all of the UPCs from the pending transaction have been examined, the process moves to step 318. In this step, a list of redeemed coupons is generated and the total redeemed coupon amount is subtracted from the total cost. Also, at some point of this process 300, expired e-coupons are automatically removed from the consumer's account with the unused coupon amounts released back to the consumer product goods manufacturer from the reserve account. Alternatively, expired e-coupons can be automatically eliminated from the consumer's account as they expire. In step 320, the coupon detail and new transaction balance are returned to the POS terminal. In one embodiment, each transaction data detail could be stored in a third data structure by the e-coupon processor 55.

In an alternate embodiment not shown, the POS terminal sends only the e-coupon account number to the e-coupon processor which then sends back a list of items with corresponding coupons, e.g., coupons that the consumer has saved to his account. The applicable coupon values are then applied by the POS terminal and processing system rather than at the e-coupon processor. The redeemed e-coupon information is then sent back to the e-coupon processor and the consumer's e-coupon account would be updated accordingly. In a still further embodiment not shown, the UPC information could be combined with the payment information and sent to the processor all at the same time. After the UPCs are examined and coupon values totaled, the payment is processed as a split tender between the redeemed coupon value and consumer's funds.

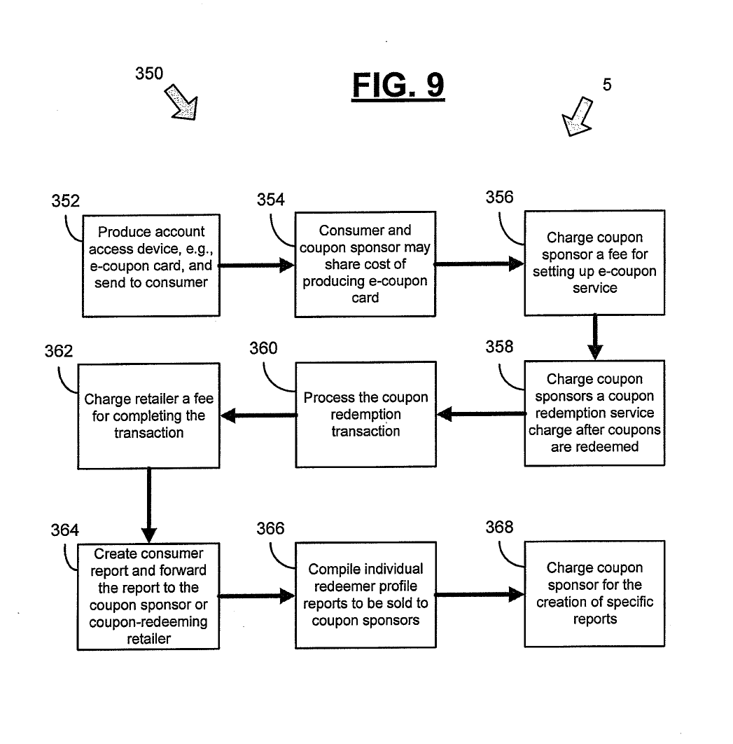

FIG. 9 shows one embodiment of a business process 350 associated with the electronic coupon system 5. In this embodiment the method of producing an electronic discount system begins with step 352, producing an account access device, e.g., an e-coupon card or some other means to access an electronic coupon account that is then sent to a registered redeemer, e.g., a consumer. In the next step 354, the consumer, i.e., the coupon redeemer, and the coupon sponsor or manufacturer may share the cost of producing the account access device. In the next step 356, the processor charges the coupon sponsor or manufacturer a fee for setting up the e-coupon service. This may include configuring the manufacturer's systems to send coupon information to the processor when coupons become available. The coupon information would include data such as product information (either SKU or UPC numbers), coupon amount, expiration date and so on. In the next step 358, the processor charges the coupon sponsors a coupon redemption service charge after a coupon has been redeemed electronically at POS by a consumer. This charge generally includes a step 360 of processing the coupon redemption transaction. In one embodiment, a step 362 includes charging the retailer or merchant a fee for completing the transaction. In a step 364, the processor creates a redeemer/consumer report and forwards the report to the coupon sponsor or manufacturer or coupon-redeeming retailer. This report may be used to help the manufacturer better plan its discount methodology, its direct marketing, and its production processes. In one embodiment, step 366 includes compiling individual redeemer profile reports to be sold to the coupon sponsor to better help it tailor its direct marketing advertising efforts to specific consumer profiles. In the final step 368 shown, the processor charges the coupon sponsor or manufacturer for the creation of the specific reports.

While the above described flow illustrates several ways for the processor to generate revenues, there are additional ways available. For example, such an e-coupon card process could generate revenue by:
Card production
Coupon download service charge
Coupon redemption service charge
Processing fee for the transaction
Report-creation
Compiling individualized consumer profile reports
Coupon redemption profiles

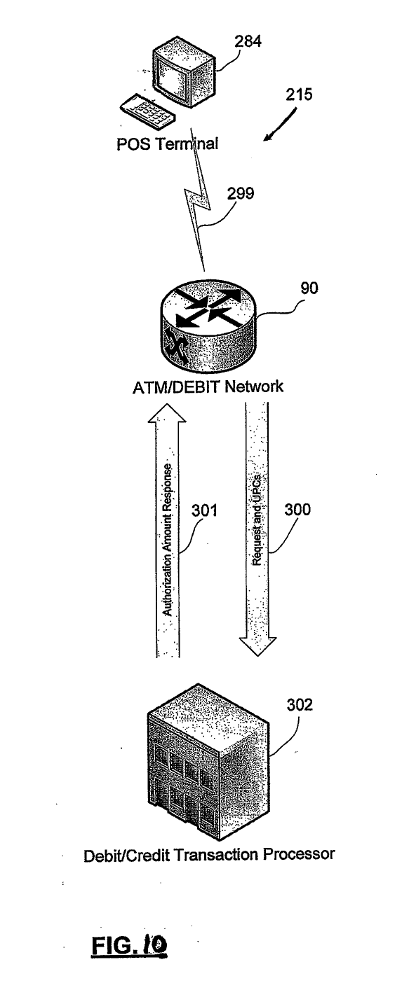

An alternative embodiment of the electronic coupon system 215 is shown in FIG. 10. FIG. 10 illustrates one possible flow of transaction information between the merchant's POS terminal 284, a financial communications network 90 and a transaction processor 302. This is part of the so-called “back end” process. The connection, e.g., network portal 299, between the POS terminal 284 and the transaction processor 302 via the network 90 here may be directly through the e-coupon processor's electronic funds transfer (EFT) network utilizing the ISO 8583 standard, through another financial institution's EFT network, through a virtual private network (VPN) via the Internet, or some other similar communication means. Such methods are described in detail in U.S. application Ser. No. 11/285,053, filed Nov. 22, 2005 which is herein incorporated in its entirety by reference. In the embodiment shown in FIG. 10, the information exchange between the network portal and the processor includes the consumer's e-coupon account information and the UPCs from the pending transaction 300. The exchange also includes an authorization amount response 301 corresponding to the total coupon discount.

Further, although the system described herein has physically separate parts or modules, it will be manifest that various modules and parts may be integrated into modules and parts with which they are associated. Furthermore, all the disclosed features of each disclosed embodiment can be combined with, or substituted for, the disclosed features of every other disclosed embodiment except where such features are mutually exclusive.

It is intended that the appended claims cover all such additions, modifications, and rearrangements. Expedient embodiments of the present invention are differentiated by the appended claims.

What is claimed is:

1. A coupon redemption management system comprising:
a global communications network;
at least one server operably connected to the network;
an access portal connected to a server including consumer instructions for consumer coupon account setup and usage and information regarding coupons available from a multitude of coupon sponsors;
an account access device for accessing a consumer's coupon account via a server;
an apparatus which accepts consumer account information; and
an open loop system wherein coupons can be redeemed at any retailer having electronic credit/debit acceptance capabilities.

2. The system of claim 1, further comprising a reader that reads SKU or UPC information and is connected to the apparatus.

3. The system of claim 1, wherein the account access device is a card having readable information.

4. The system of claim 1, wherein the account access device is a cell phone or other communications device.

5. The system of claim 1, wherein the account access device is a portable electronic account information storage device.

6. The system of claim 1, further including a financial system to treat coupons as an electronic tender type at the apparatus.

7. The system of claim 1, wherein the access portal further comprises:
a method by which a first-time visitor sets up a consumer account by entering contact information and other requested information;
a listing of electronic coupons from sponsors having multiple sort options available for at least one of item type, sponsor, expiration date and wherein the listing contains a description of the discounted item along with a value;
a tool to allow consumers to select coupons in which they are interested;
a process that updates the consumer account as coupon offers are selected by the consumer from the access portal or as previously selected, unredeemed coupon offers expire.

8. An electronic coupon system comprising:
an account access device;
an access portal including an electronic coupon from a coupon sponsor and having multiple sort options available for at least one of a product, a service, a coupon sponsor, and expiration date and including a product or service description and value;
an interface to allow a consumer to select an electronic coupon of interest;
a portal to allow a first-time consumer to enter required information;
a processor to program the account access device with consumer required information and send the account access device to the consumer; and
an open loop system wherein electronic coupons can be redeemed at any retailer having electronic credit/debit acceptance capabilities.

9. The system of claim 8, wherein the account access device further comprises:
a manufacturer's coupon card having an associated consumer account and redeemable at a point of sale, wherein the card is processed like a stored value card; and
coupon values for qualifying purchased items that are removed from the card at point of redemption; wherein expired, unredeemed coupon values are automatically eliminated from the consumer's account and cash reserves from a manufacturer are released back to the manufacturer.

10. A system comprising:
a manufacturer's coupon device redeemed at a point of sale;
an account associated with the device; and
a means where coupon values for qualifying, purchased items are removed from the account at a point of redemption and unredeemed, expired coupon values are automatically eliminated from the account and cash reserves from a manufacturer are accessed to cover the coupon values.

11. The system of claim 9, further comprising a mechanism to allow a purchaser to check account balances and content, and wherein the purchaser may reload the account with coupon values at any time via the mechanism.

12. An e-coupon system comprising:
an e-coupon account access device; and
an open loop system that enables e-coupons to be redeemed when using the e-coupon account access device at any retailer that has debit/credit acceptance capabilities.

13. The system of claim 12, further comprising:
a mobile access device for a coupon redeemer who has an account associated therewith for e-coupon redemption;
a processor for updating the account with selected product coupon values, provider information, and expiration dates;
cash reserves from a coupon sponsor such as a consumer product manufacturer are made available to cover the value of each selected product coupon;
a mechanism to allow the redeemer to print out coupon contents from a website or to access e-coupon account contents via cell phone or other communications device; and
a tool to allow for multiple sort options for redeemer convenience by at least one of: brand, product category, and layout of a particular store;
a portal to allow a consumer to sign up for a notice prior to the expiration date of selected, unredeemed coupons; and
an alert when coupons for selected products or product types become available.

14. The system of claim 10, wherein the account access device includes at least one of a magnetic strip device, smart chip, key fob, cellular phone, PDA, or other wireless device.

15. The system of claim 1, further comprising:
a financial communications network;
a network portal connected to the financial communications network;
at least one server operable with the portal;
at least one server operable with the financial communications network which is used to process financial transactions;
a database containing consumer account information connected to the network;
a database containing consumer coupon selection information connected to the network; and
a database containing available coupon information connected to the network;
wherein the access portal is a website including consumer instructions for use and information regarding coupons available from a multiplicity of manufacturers and other coupon sponsors; and further wherein the account access device is readable by a point of sale payment processing system that is connected to the financial communications network.

16. The system of claim 15, wherein the point of sale system also reads SKU or UPC information.

17. The system of claim 15, wherein the device includes at least one of a:
card having a readable magnetic strip or smart chip, a cell phone, wireless device, and portable electronic account information storage media.

18. The system of claim 15, further including a mechanism to treat the coupon as an electronic tender type at the point of sale.

19. The system of claim 18, further comprising a mechanism to allow consumers to check account balances and content via an Internet website, wireless device, or telephone and wherein consumers may update their account with additional coupon values at any time.

20. The system of claim 8, further comprising:
an open loop system so that a consumer's e-coupon account is accessible via any retailer that has credit/debit card acceptance capabilities.
